(19) United States
(12) Patent Application Publication
(10) Pub. No.: US 2009/0046055 A1
(43) Pub. Date: Feb. 19, 2009

(54) Interactive digital image display

(76) Inventor: Kui-Yun Feng, San Chong (TW)

Correspondence Address: Raymond Sun, Suite 155, 20 Corporate Park, Irvine, CA, 92606, US

(21) Appl. No.: 11/906,192

(22) Filed: Oct. 1, 2007

(30) Foreign Application Priority Data
Aug. 14, 2007 (TW) 096129939

(51) Int. Cl. G09G 5/00

(52) U.S. Cl. 345/156

(57) ABSTRACT

An interactive digital image display has a screen, an image processor, a coordinate detecting unit coupled to the image processor, an image driving unit coupled to the image processor, a memory coupled to the image processor, and an interface for acquiring images. When user moves the display, the coordinate detecting unit generates a signal to the image processor, and the image displayed on the display will be adjusted according to the displacement of the display

### BACKGROUND OF THE INVENTION

1. Field of the Invention

The present invention relates to a digital display, and in particular, to an interactive digital image display.

2. Description of the Prior Art

In the past, a user usually develops his image graphs and places them into a photo frame. Due to the advancement of the digital camera, photographers can capture a large number of photos without the expense of developing them. However, it is very inconvenient for a photographer to continuously replace photos from a photo frame one after one all the time. To address this, a so-called digital image frame was made available to the market.

The user may download a large number of images from a computer to a built-in memory of the digital image frame such that the images can be automatically displayed in order, or randomly. The user may even use a memory card (or the like) with the digital image frame so as to display the images stored therein.

The digital image frame is a static device, even though it can display the images in a variety of ways. However, the digital image frame cannot respond to a user's movement of the frame.

### SUMMARY OF THE DISCLOSURE

It is an object of the present invention to provide an interactive digital image display.

To accomplish the objectives mentioned above, the present invention provides an interactive digital image display having a screen, an image processor, a coordinate detecting unit coupled to the image processor, an image driving unit coupled to the image processor, a memory coupled to the image processor, and an interface for acquiring images. When user moves the display, the coordinate detecting unit generates a signal to the image processor, and the image displayed on the display will be adjusted according to the displacement of the display.

### BRIEF DESCRIPTION OF THE DRAWINGS

FIG. 1 is a block diagram of an interactive digital display according to one embodiment of the present invention.

FIG. 2 is perspective view of the interactive digital display of FIG. 1.

FIG. 3 is a flow diagram for the operation of the interactive digital display of FIG. 1.

FIG. 4 is a front view of the interactive digital display of FIG. 1, showing a regular image.

FIG. 5 is another front view of the interactive digital display of FIG. 1, showing the same image from FIG. 4 but being adjusted according to the movement of the interactive digital display.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention.

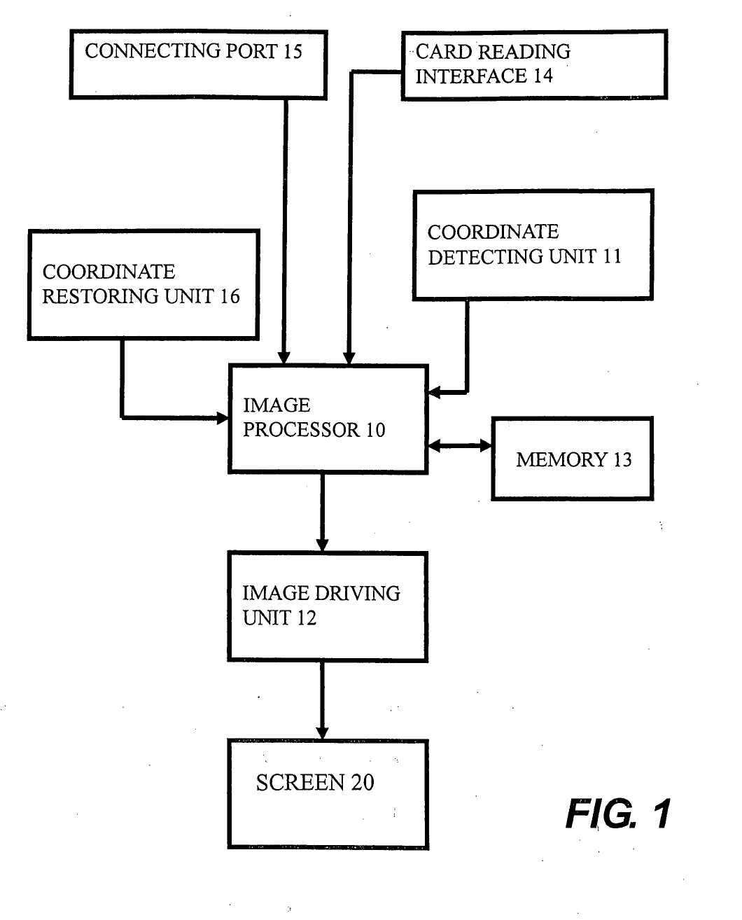

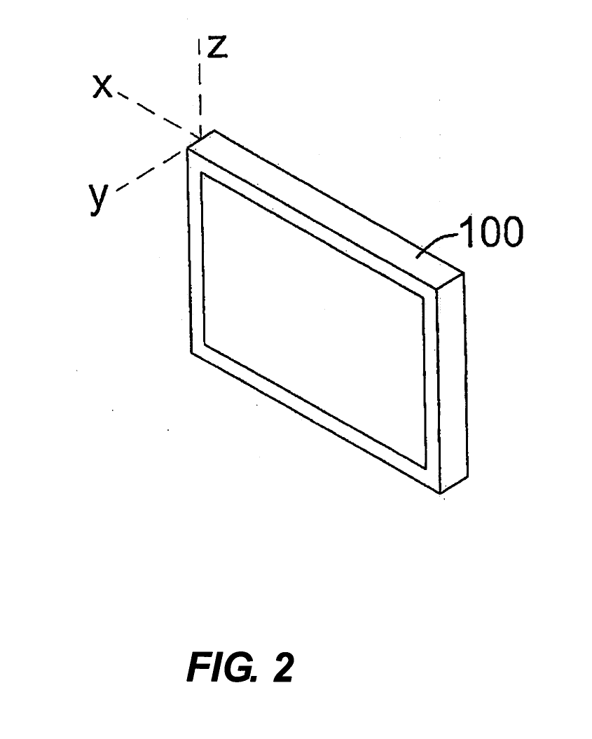

Referring to FIGS. 1 and 2, an interactive digital display 100 according to the present invention includes a display screen 20, and an image processor 10 for processing the images which are acquired from an interface, such as a built-in card reading interface 14 or a connecting port 15. The connecting port 15 can be a USB (universal serial bus) port or the like which can be further coupled to a computer or a memory storing device.

A coordinate detecting unit 11 is coupled to the image processor 10. The coordinate detecting unit 11 can be selected from among the group of an accelerator, a gyroscope, a MEMS (micro electro-mechanical systems) device or the like. All of these devices are well-known in the art, and examples include the GOOGLE PICASA™ system utilized by Google. The coordinate detecting unit 11 can sense an amount of the movement in two-dimensional or three-dimensional coordinate away from a reference point. An image driving unit 12 is coupled to the image processor 10, and to the display 20, for driving the display 20. A memory 13 is coupled to the image processor 10 for storing the captured images for further processing by the image processor 10.

The invention further includes a coordinate restoring unit 16 which can be activated to forward a signal to the processor 10 so as to restore the origin of the coordinate. For example, the coordinate restoring unit 16 can be a switch-like device, such as a button, a capacity sensor or the like.

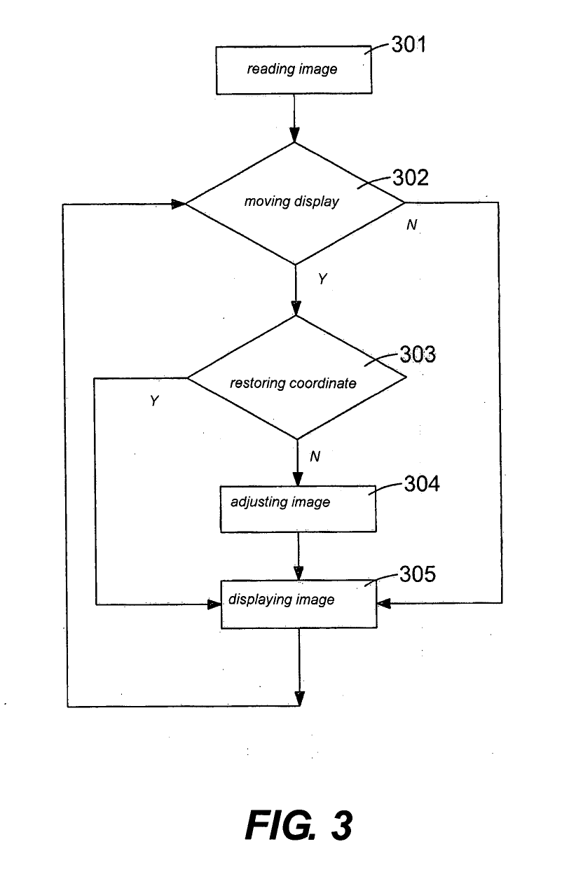

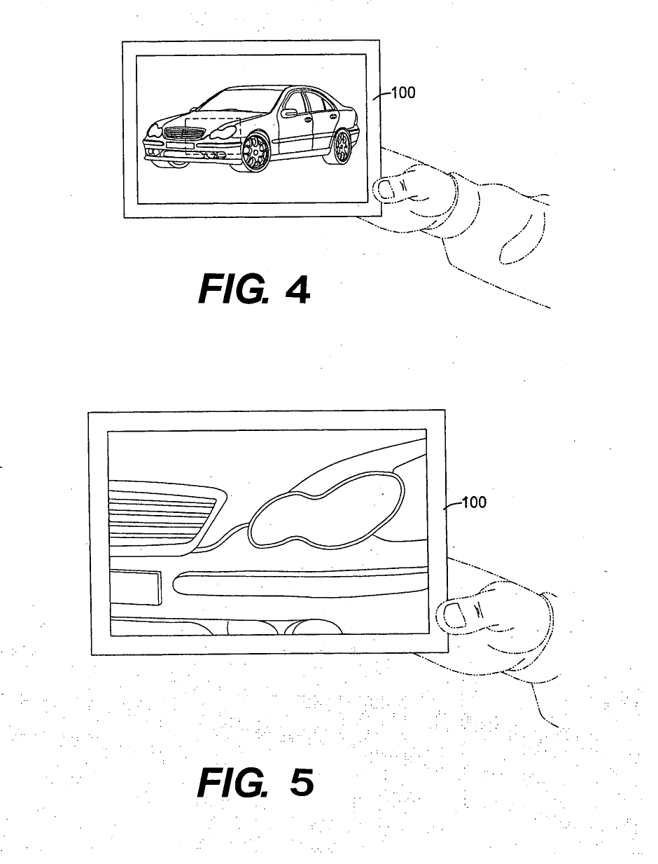

Referring to FIGS. 3 and 4, the processor 10 obtains images from a computer or a memory card (step 301), and the image can be displayed in a regular or predetermined way. If the user moves the display 100 away from a reference point (for example, moving the display 100 from the front side of a table to the rear side of the table), the coordinate detecting unit 11 will generate a signal and forward the signal to the processor 10 (step 302) according to the amount of displacement of the display 100 from the front side to the rear side of the table. If the display 100 has not been moved, processing proceeds to step 305 where the screen 20 displays the image in a regular or predetermined way as shown in FIG. 4. If the user does not activate the coordinate restoring unit 16 (step 303) (activation can be accomplished by a switch device), the displayed image will be further processed or adjusted by the processor 10 (step 304 and FIG. 5) according to the displacement of the display 100 away from a reference point, and then displayed (step 305). The adjustment performed in step 304 is performed using techniques that are well-known in the art. However, if the user activates the coordinate restoring unit 16 (step 303), then the displayed image will be restored to a regular image or a predetermined way (such as shown in FIG. 4), and the coordinate detecting unit 11 will reset the coordinate as a new reference point (e.g., the displacement of the display 100 can be set to be zero), and re-detect the amount of the new displacement of the display 100 away from the new reference point.

For example, if the user moves the right side of the display 100 forward at a displacement A, the displayed image may be moved backward at a displacement proportional to A. In other words, once the user moves the display 100 with yaw, roll, and pitch movements, the displayed image will be adjusted proportionally to the different movements of the display 100.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An interactive digital image display, comprising:
a screen;
an image processor;
a coordinate detecting unit coupled to the image processor;
an image driving unit coupled to the image processor and the display;
a memory coupled to the image processor; and
an interface coupled to the image processor for acquiring images;
wherein upon movement of the display, the coordinate detecting unit generates a signal to the image processor and an image displayed on the screen will be adjusted according to an amount of the displacement experienced by the display.

2. The interactive digital image display of claim 1, wherein the coordinate detecting image unit can be selected from the group consisting of an accelerator, a gyroscope, and a MEMS (micro electro-mechanical systems) device.

3. The interactive digital image display of claim 1, wherein the interface is a card reading interface for reading images from a memory card.

4. The interactive digital image display of claim 1, wherein the interface is a connecting port for coupling to a computer or a memory storing device.

5. The interactive digital image display of claim 1, wherein the interactive digital image display further includes a coordinate restoring unit coupled to the image processor.

6. The interactive digital image display of claim 5, wherein the coordinate restoring unit is a switch.

7. A method for displaying an image on a display, the method comprising:
displaying an image on the display at a reference point;
detecting an amount of a displacement of the display away from the reference point; and
adjusting the image on the display in a manner that is proportional to the amount of the displacement.
